(19) United States
(12) Patent Application Publication
(10) Pub. No.: US 2007/0102898 A1
(43) Pub. Date: May 10, 2007

(54) Pintle hook and ball hitch assemby shock absorber

(76) Inventor: Todd Schulze, Mooresville, NC (US)

Correspondence Address: DENNIS G. LAPOINTE;LAPOINTE LAW GROUP, PL, PO BOX 1294, TARPON SPRINGS, FL, 34688-1294, US

(21) Appl. No.: 11/270,847

(22) Filed: Nov. 9, 2005

(51) Int. Cl. B60D 1/60

(52) U.S. Cl. 280/507

(57) ABSTRACT

The use of a shock absorber bushing around the trailer hitch ball and between the ball and tow ring on vehicles towing large heavy industrial trailers. The shock absorber bushing can be cylindrically-shaped and adapted to have an interior hollow dimension to easily slide over the ball. Its length is adapted to extend at least to a height above the centerline of the ball and preferably so its top surface is aligned relatively close to the height of the ball. In a preferred embodiment, the shock absorber bushing has a flanged portion at its bottom side that is dimensioned in thickness and width to provide some vertical movement shock absorbing effect due to the action of the tow ring bouncing up and down when hitting bumps in the road surface.

### FIELD OF THE INVENTION

The invention relates to the shock absorbing of a pintle hook and hitch ball assembly used to tow trailers, typically having a gross trailer weight (GWT) of about 10,000 pounds and higher.

### BACKGROUND OF THE INVENTION

Current pintle hook assemblies allow for relatively extreme jarring and shock to drivers and passengers in tow vehicles, especially when the brakes are applied or when the vehicle is placed in motion. Typically, the tow ring gap around the ball is the problem. When a tow vehicle has to brake suddenly, the tow ring connected to the trailer slides forward and slams against one side of the ball of the ball and pintle hook assembly. When the tow vehicle accelerates, the tow ring then slides away from the ball and pintle hook assembly and slams against the opposite side of the ball. The result is a whip lash effect to the individuals inside the tow vehicle cab.

The purpose of the present invention is to provide a shock absorbing device and method to prevent or substantially reduce the whip lashing caused by the sliding of the tow ring back and forth against the ball whenever braking or accelerating occurs.

### SUMMARY OF THE INVENTION

As a general application, the present invention is anticipated to be applied to trailing devices using tow rings and pintle hooks. These systems are usually found where the trailer GTW may be 10,000 pounds and higher.

The present invention involves the use of a shock absorber bushing around the ball and between the ball and tow ring. The shock absorber bushing can be cylindrically-shaped and adapted to have an interior hollow dimension to easily slide over the ball. Its length is configured to extend at least to a height above the centerline of the ball and preferably so its top surface is aligned relatively close to the height of the ball. In a preferred embodiment, the shock absorber bushing has a flanged portion at its bottom side that is dimensioned in thickness and width to provide some vertical movement shock absorbing effect due to the action of the tow ring bouncing up and down when hitting bumps in the road surface.

The shock absorbing system can be made from materials suitable to withstand the significant lateral compressive forces exerted by the tow ring on the ball within the pintle hook or the downward vertical forces on the pintle hook lower half, without permanently deforming and cracking the bushing. For example, one type of suitable material is a vulcanized rubber and/or plastic based material. The material used to make hockey pucks provides for a vulcanized rubber material that can withstand significant impact compressive forces. Material having similar characteristics would be suitable for use as a shock absorber. That is, the bushing effectively has to have characteristics where its elastic deformation, its pliancy, and its overall elasticity, strength and stability are suitable for be subjected to such harsh forces. In addition, fiber reinforced or meshed composites made of plastic or polymer based materials, rubber materials and combinations thereof similar to the materials used in the automotive industry and aircraft industry are other examples of anticipated suitable materials. The material must also have bearing characteristics that would allow for the easy rotation of the ball within the interior of the shock absorber when the tow vehicle is turning. Given these characteristics, one skilled in the art can produce a variety of composite materials from polymer/plastic material, vulcanized rubber materials or combinations thereof to form the shock absorber bushing with well known materials.

### BRIEF DESCRIPTION OF THE DRAWINGS

In the accompanying drawings:

FIG. 1 is a perspective conceptual view of a pintle hook trailering assembly with one embodiment of the present invention installed;

FIG. 2 is a perspective partial cross-section view depicting the embodiment being used in FIG. 1; and

FIG. 3A is a perspective view of the present invention bushing used in FIG. 1; and

FIG. 3B is a perspective view of an alternative embodiment of the present invention bushing.

### DETAILED DESCRIPTION OF THE INVENTION

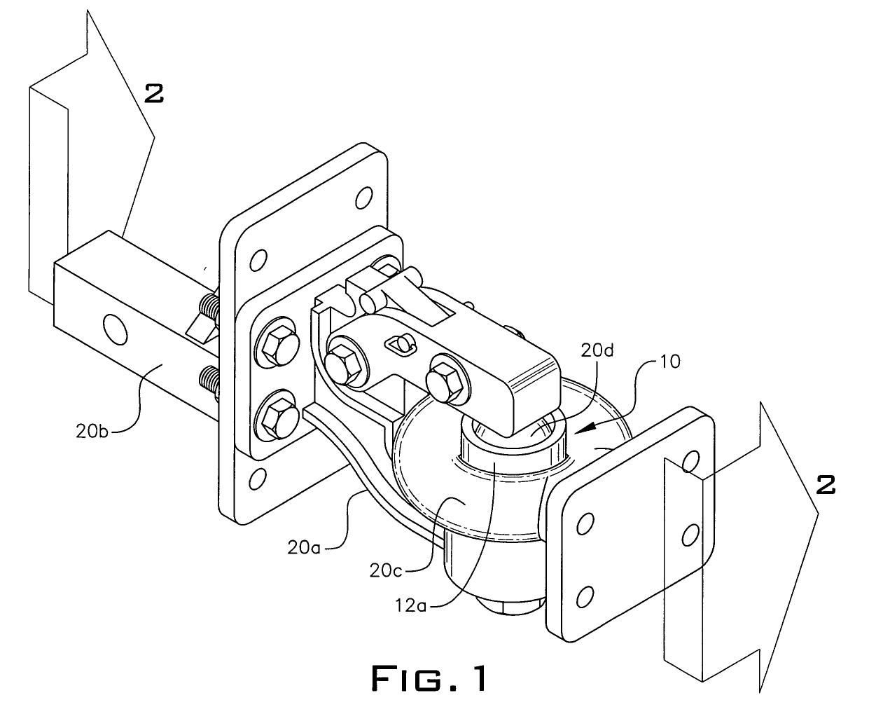

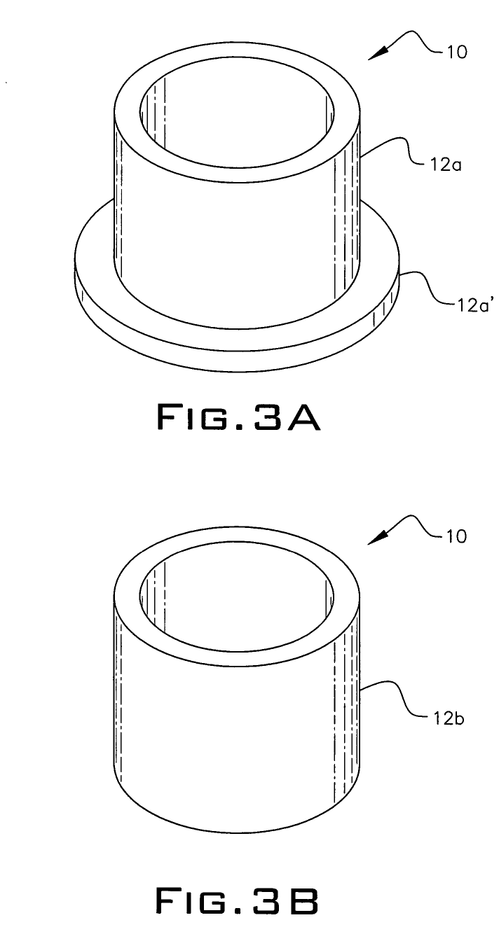

Referring now to the drawings, FIGS. 1-2 and 3A-3B disclose the present invention, which is a pintle hook and ball assembly shock absorber and is depicted generally as 10.

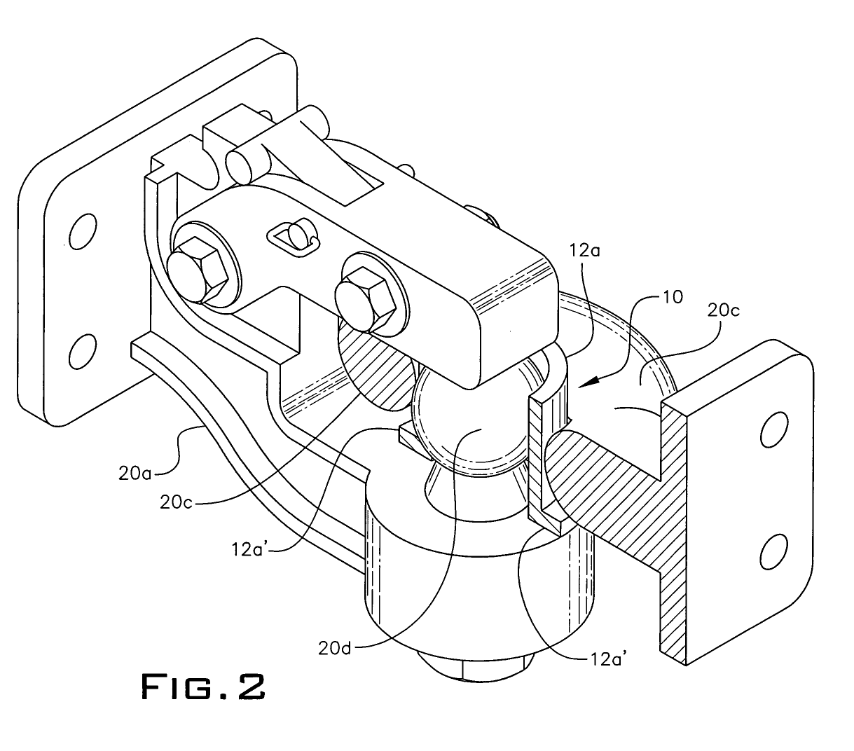

In FIGS. 1-2, the pintle hook 20a is shown connected to pintle hook mounting plate 20b, which is connected to the tow vehicle (not shown). The trailer ball hitch or ball 20d is attached to the bottom portion of the pintle hook 20a. When attaching a trailer for towing, the upper half of the pintle hook 20a has a portion that pivots away to all for the tow ring 20c to be installed over and around the ball 20d, then the upper half is re-positioned to lock the tow ring 20c in place for towing.

As can be viewed in the drawing, the present invention 10 (bushing 12a or bushing 12b) is first placed around the ball. If the bushing has a flanged portion 12a′ such as that depicted in FIGS. 1-2 and 3A, the flanged portion 12a′ is preferably placed against the bottom half of the pintle hook 20a.

The overall diameter of the cylindrical portion of the bushing 12a,12b should be sized so as to minimize the back and forth movement of the tow ring 20c, yet have sufficient tolerance to allow for easy turning of the ball 20d relative to the inside of the bushing 12a,12b when turns are being made by the tow vehicle.

It should be understood that the preceding is merely a detailed description of one or more embodiments of this invention and that numerous changes to the disclosed embodiments can be made in accordance with the disclosure herein without departing from the spirit and scope of the invention. The preceding description, therefore, is not meant to limit the scope of the invention. Rather, the scope of the invention is to be determined only by the appended claims and their equivalents.

What is claimed is:

1. A method of minimizing the whip lash effect to individuals in a tow vehicle towing a trailer using a pintle hook attached to the tow vehicle, a ball mounted within the pintle hook and tow ring attached to the trailer being towed comprising:
using a shock absorber bushing and placing said bushing around a ball mounted within the pintle hook between said ball and a tow ring.

2. The method according to claim 1, wherein said bushing is generally cylindrically-shaped with a hollow interior sized to easily slide around the ball and has an overall cylindrical diameter sized so as to minimize a back and forth movement of the tow ring within the pintle hook, said hollow interior of said bushing further being sized with a tolerance between the ball and bushing to allow for easy turning of the ball relative to the bushing when turns are being made by the tow vehicle.

3. The method according to claim 1, wherein said bushing comprises:
a hollow interior sized to easily slide around the ball, said hollow interior of said bushing further being sized with a tolerance between the ball and bushing to allow for easy turning of the ball relative to the bushing when turns are being made by the tow vehicle;
a generally cylindrically-shaped portion, which has an overall cylindrical diameter sized so as to minimize a back and forth movement of the tow ring within the pintle hook; and
a flanged portion around an end of said cylindrically-shaped, said flanged portion being placed against a bottom half of the pintle hook and has a thickness and width configured to provide a shock absorbing effect due to a vertical movement of the tow ring bouncing up and down when the tow vehicle encounters rough road surfaces.

4. The method according to claim 1, wherein the bushing is made from material comprising polymer-based material, plastic-based material, rubber-based material or any combination thereof.

5. A shock absorber for minimizing the whip lash effect to individuals in a tow vehicle towing a trailer using a pintle hook attached to the tow vehicle, a ball mounted within the pintle hook and tow ring attached to the trailer being towed comprising:
a bushing adapted to be placed around a ball mounted within the pintle hook between said ball and a tow ring,
wherein said bushing is generally cylindrically-shaped with a hollow interior sized to easily slide around the ball and has an overall cylindrical diameter sized so as to minimize a back and forth movement of the tow ring within the pintle hook, said hollow interior of said bushing further being sized with a tolerance between the ball and bushing to allow for easy turning of the ball relative to the bushing when turns are being made by the tow vehicle.

6. The shock absorber according to claim 5, wherein the bushing is made from material comprising polymer-based material, plastic-based material, rubber-based material or any combination thereof.

7. A shock absorber for minimizing the whip lash effect to individuals in a tow vehicle towing a trailer using a pintle hook attached to the tow vehicle, a ball mounted within the pintle hook and tow ring attached to the trailer being towed comprising:
a bushing adapted to be placed around a ball mounted within the pintle hook between said ball and a tow ring,
wherein said bushing comprises:
a hollow interior sized to easily slide around the ball, said hollow interior of said bushing further being sized with a tolerance between the ball and bushing to allow for easy turning of the ball relative to the bushing when turns are being made by the tow vehicle;
a generally cylindrically-shaped portion, which has an overall cylindrical diameter sized so as to minimize a back and forth movement of the tow ring within the pintle hook; and
a flanged portion around an end of said cylindrically-shaped, said flanged portion being placed against a bottom half of the pintle hook and has a thickness and width configured to provide a shock absorbing effect due to a vertical movement of the tow ring bouncing up and down when the tow vehicle encounters rough road surfaces.

8. The shock absorber according to claim 7, wherein the bushing is made from material comprising polymer-based material, plastic-based material, rubber-based material or any combination thereof.
